(19) United States
(12) Patent Application Publication
(10) Pub. No.: US 2014/0129544 A1
(43) Pub. Date: May 8, 2014

(54) Using Metadata to Summarize Social Media Content

(71) Applicant: Google Inc., Mountain View, CA (US)

(72) Inventors: Frances B. Haugen, Mountain View, CA (US); Gregory M. Marra, San Francisco, CA (US)

(73) Assignee: Google Inc., Mountain View, CA (US)

(21) Appl. No.: 13/667,521

(22) Filed: Nov. 2, 2012

(51) Int. Cl. G06F 17/30

(52) U.S. Cl. 707/722; 707/E17.082

(57) ABSTRACT

A method performed by one or more processing devices includes receiving a request for social media content that is relevant to one or more search terms; identifying, based on a social graph of a user, social media content with connections in the social graph to the user, wherein the social media content is associated with metadata; identifying metadata that is associated with the identified social media content and that has at least a threshold amount of relevance to the one or more search terms; generating a summarization of contents of the metadata identified and contents of the social media content identified; and transmitting, to the device used by the user who sent the request, the summarization for presentation to the user, in response to the request for social media content.

### BACKGROUND

Social networks permit users to post information about themselves and to communicate with other people, e.g., their friends, family, and co-workers. Additionally, through the social network, users may post information about various events, including, e.g., traffic delays, accidents, flight information, concerts, conferences, fairs, fires, emergencies, and so forth. In this example, a user may search through posts in the social network for information about an event, e.g., to determine what other users of the social network have posted about the event.

### SUMMARY

In one aspect of the present disclosure, a method performed by one or more processing devices includes receiving a request for social media content that is relevant to one or more search terms; identifying, based on a social graph of a user, social media content with connections in the social graph to the user, wherein the social media content is associated with metadata; identifying metadata that is associated with the identified social media content and that has at least a threshold amount of relevance to the one or more search terms; generating a summarization of contents of the metadata identified and contents of the social media content identified; and transmitting, to the device used by the user who sent the request, the summarization for presentation to the user, in response to the request for social media content. Other embodiments of this aspect include corresponding computer systems, apparatus, and computer programs recorded on one or more computer storage devices, each configured to perform the actions of the methods. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

The foregoing and other embodiments can each optionally include one or more of the following features, alone or in combination. In particular, one embodiment may include all the following features in combination. In some implementations, the features include identifying, based on at least one of the one or more search terms, a geographic location associated with the one or more search terms; wherein identifying the metadata comprises: identifying one or more items of social media content associated with metadata indicative of the geographic location. The features may also include determining, based on the one or more items of social media content identified, an increase in a number of items of social media content being transmitted from the geographical location.

In other implementations, the summarization includes information indicative of the increase. In some implementations, the features include determining an amount of metadata indicative of the geographic location; wherein the summarization includes information indicative of the amount of metadata determined. In still other implementations, the features include generating, based on the one or more search terms, a search query; wherein searching includes: searching based on the search query. In some implementations, transmitting includes: transmitting, to the device used by the user who sent the request, information for a graphical user interface that includes a visual representation of the summarization in a content stream.

The details of one or more implementations are set forth in the accompanying drawings and the description below. Other features, aspects and advantages will be apparent from the description and drawings, and from the claims.

### BRIEF DESCRIPTION OF DRAWINGS

FIG. 1 is a diagram of an example of a network environment for generating contextual information from metadata for social media content.

FIG. 2 is a block diagram showing examples of components of a network environment for generating contextual information from metadata for social media content.

FIG. 3 is a flow chart of an example process for generating contextual information from metadata for social media content.

FIG. 4 is a conceptual view of an example social graph.

FIG. 5 shows an example of a computer device and a mobile computer device that can be used to implement the techniques described herein.

Like reference symbols and designations in the various drawings indicate like elements.

### DETAILED DESCRIPTION

The term “metadata” as used herein includes, but is not limited to, data about another item of data.

The term “contextual information” as used herein includes, but is not limited to, information that qualifies metadata. For example, contextual information may include a summary of an event and/or a qualification that is indicative of circumstances in which an event occurs.

The term “social media content” as used herein includes, but is not limited to, electronic content that is submitted to a social network. Types of electronic content include posts, links, images, digital photographs, check-ins and so forth.

The term “check-in” as used herein includes, but is not limited to, a submission of information specifying a venue and/or a geographic location at which a user is present.

The term “content stream” as used herein includes, but is not limited to, items of social media content displayed in a portion of a graphical user interface designated for display of the items of social media content.

The term “relevance score” as used herein includes, but is not limited to, a measure of importance of one item of data to another item of data.

The term “threshold level of relevance” as used herein includes, but is not limited to, a predefined amount of relevance (e.g., a predefined relevance score).

The term “pattern” as used herein includes, but is not limited to, an occurrence of a predefined event.

The term “processing device” as used herein includes, but is not limited to, an appropriate processor and/or logic that is capable of receiving and storing data, and of communicating over a network.

The term “social connection” as used herein includes, but is not limited to, a relationship between nodes in a graph representing users of a social networking service.

A system consistent with this disclosure generates contextual information (e.g., a summary) from contents of metadata for social media content and from the social media content itself. In an example, when a user submits a search query, the search query could be for social media content, e.g., rather than for the retrieval of a fact. In this example, the system may not have an answer, to the search query, based on fact. However, the presence of social media content posted by other users could be used in providing an answer (e.g., results) for the search query.

For example, a user submits a request, to the system, for social media content that is relevant to search terms in a search query. The system identifies social media content that is relevant to the search terms. The social media content identified is also associated with metadata, including, e.g., a geographic location from which the social media content was submitted to the social network. In an example, an item of social media content is associated with metadata through a reference (e.g., a pointer) in a database that links the item of social media content to the metadata. That is, through the reference, the item of social media content references the metadata. In another example, an item of social media content is associated with metadata by the metadata being included in the social media content. Using the associated metadata, the system identifies contextual information that is relevant to the search terms. In this example, the contextual information may include information indicative of a large number of people that are submitting social media content from a particular geographic location.

In this example, the fact that a large number of people are posting from a particular geographic location may be useful information, e.g., as it may be indicative of an event taking place at the geographic location and/or as it may be indicative of an unusual occurrence at the geographic location. In response to the request, the system is configured to return the contextual information and the social media content identified.

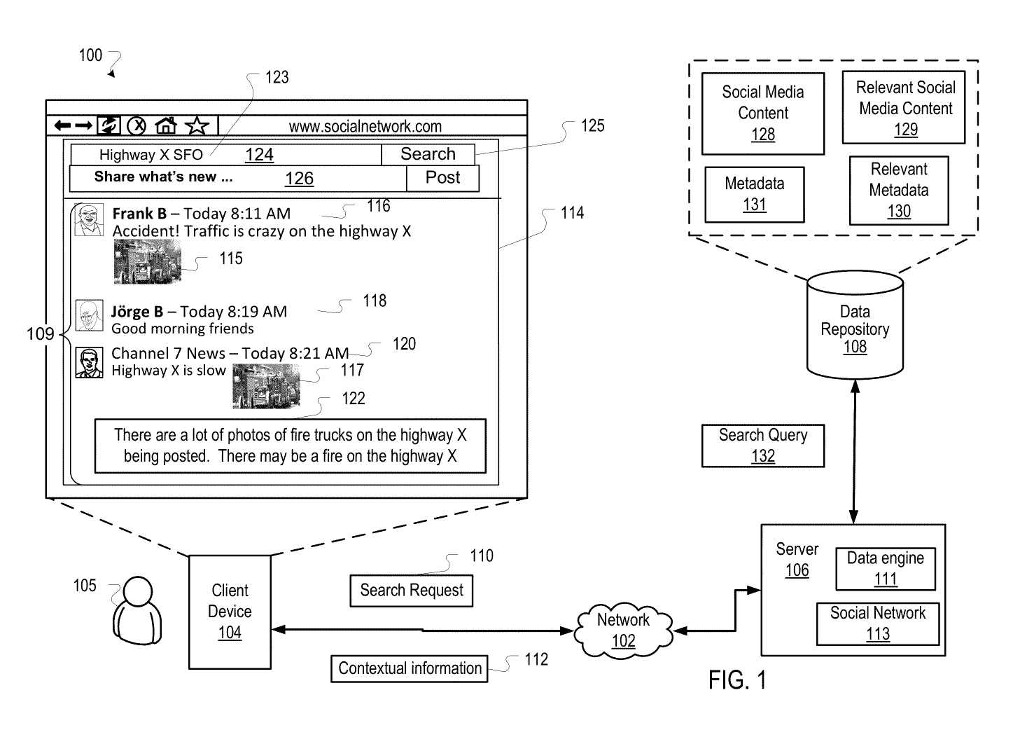

FIG. 1 is a diagram of an example of a network environment 100 for generating contextual information 112 from metadata 131 for social media content 128. Network environment 100 includes client device 104, server 106, data repository 108, and network 102. Client device 104 can communicate with server 106 over network 102. Network environment 100 may include many thousands of client devices and servers, which are not shown.

In the example of FIG. 1, server 106 hosts social network 113. Server 106 also includes data engine 111 for generating contextual information 112 from metadata 131 (or portions thereof) associated with social media content 128 submitted to social network 113. Although data engine 111 is shown as a single component in FIG. 1, data engine 111 can exist in one or more components, which can be distributed and coupled by network 102. In an example, social network 113 and data engine 111 may be combined into a single component.

Network environment 100 also includes member 105 of social network 113. In this example, member 105 is also a user of client device 104. Member 105 can participate in social network 113 by uploading and downloading social media content 128 (or portions thereof) to social network 113. Other members (not shown) interacting with other client devices (not shown) can also participate in social network 113 by uploading and downloading social media content 128 (or portions thereof) to social network 113. In an example, server 106 stores, in data repository 108, social media content 128 that has been uploaded to social network 113.

In an example, social media content 128 is associated with metadata 131. There are numerous types of metadata 131, including, e.g., data indicative of a geographic location from which an item of social media content 128 is submitted, data indicative of a type image in a photograph submitted to social network 113, and so forth.

In an example, metadata 131 includes geographic information. In an example, an item of social media content 128 includes a check-in. In this example, a check-in is associated with metadata specifying a geographic location of a user. In another example, member 105 may submit a post (e.g., an electronic message) to social network 113. In this example, client device 104 may include an application (not shown) for identifying a geographic location of client device 104. In this example, client device 104 is configured to append the geographic location to the post that is submitted to social network 113.

In an example, data engine 111 uses portions of metadata 131 indicative of a geographic location in generating contextual information 112. For example, a user submits, to server 106, a search query with the following search terms “highway X SFO.” In this example, the search terms are indicative of a highway named the “highway X” that is located in proximity to San Francisco.

As described in further detail below, data engine 111 identifies portions of metadata 131 that may be relevant to the search terms. In this example, data engine 111 is configured to identify a number of check-ins at the highway X in San Francisco and/or a number of items of social media content 128 that have been submitted from the highway X in San Francisco within a predefined period of time (e.g., within an hour).

In an example, server 106 generates data for graphical user interface 114. When rendered by client device 104, graphical user interface 114 includes a main page for member 105 of social network 113. Graphical user interface 114 can display portions of social media content 128 that has been shared with member 105.

In the example of FIG. 1, graphical user interface 114 includes content stream 109 for display of items 116, 118, 120 of social media content 128. In the example of FIG. 1, items 116, 118, 120 of social media content 128 include posts that have been made by members of social network 113 and that are socially connected to member 105.

In an example, items 116, 120 include information pertaining to traffic caused by an accident on a highway that is named highway X. In this example, item 116 includes photograph 115, including, e.g., a photograph of a fire truck that is responding to the accident. Item 120 also includes photograph 117, including, e.g., a photograph of the fire truck that is responding to the accidence. Item 118 includes information unrelated to the accident. Although three items of social media content 128 are depicted in FIG. 1, it is appreciated that content stream 109 can display more than three items of social media content 128 to member 105.

In the example of FIG. 1, graphical user interface 114 also includes content sharing interface 126. Member 105 can activate (e.g., click on) content sharing interface 126 to input electronic content. Graphical user interface 114 also includes search field 124 for the input of search terms 123 to be used in searching social network 113 for content. Graphical user interface 114 includes search function 125, which may be selected to send search request 110 to server 106 to search for content related to search terms 123 input into search field 124.

In the example of FIG. 1, member 105 inputs search terms 123 into search field 124. In this example, search terms 123 include the words “highway X SFO.” In this example, items 116, 120 of social media content 128 are related to search terms 123.

Following entry of search terms 123 into search field 124, member 105 selects search function 125. Selection of search function 125 causes client device 104 to generate search request 110. Search request 110 includes a request for portions of social media content 128 that are relevant to search terms 123. Search request 110 also includes information about member 105, including, e.g., username information. Client device 104 transmits search request 110 to server 106.

In response, server 106 generates search query 132. Using search query 132, data engine 111 searches data repository 108 for portions of social media content 128 that are relevant to search terms 123 and that are related to member 105 (e.g., portions of social media content 128 that are accessible to member 105). For example, the search may identify portions of social media content 128 that include search terms 123 and to which member 105 has some social connection (e.g., the content may be by an author to whom member 105 is socially connected). Server 106 may determine relevance scores for items of social media content identified in the search. For example, a relevance score for an item of social media content 128 includes a measure of how closely an item of social media content 128 matches search terms 123.

From items of social media content 128 identified in the search, data engine 111 selects relevant social media content 129. In this example of FIG. 1, relevant social media content 129 includes portions of social media content 128 with relevance scores above a threshold level of relevance.

Items of relevant social media content 129 may be selected for output to member 105, e.g., by being displayed in a portion of graphical user interface 114. In this example, the response to search request 110 includes the output items of relevant social media content 129.

Using search query 132, data engine 111 also searches data repository 108 for portions of metadata 131 that are relevant to search terms 123. In an example, data engine 111 is configured to identify portions of metadata 131 that are relevant to search terms 123 independent of whether the portions of metadata 131 identified are accessible to member 105. In this example, data engine 111 may identify portions of metadata 131 that are associated with items of social media content 128 that are inaccessible to member 105, as described in further detail below. Data engine 111 uses these identified portions of metadata 131 in generating contextual information 112.

In another example, the search may identify portions of metadata 131 that include search terms 123. Server 106 may determine relevance scores for items of metadata 131 identified in the search. For example, portions of metadata 131 indicative of a geographic location of the highway X in San Francisco may have increased relevance score, e.g., relative to relevance scores for other portions of metadata 131 (e.g., portions of metadata 131 indicative of other geographic locations).

From items of metadata 131 identified in the search, data engine 111 selects relevant metadata 130. In this example of FIG. 1, relevant metadata 130 includes portions of metadata 131 with relevance scores above a threshold level of relevance.

Items of relevant metadata 130 may be used in generating contextual information 112. In this example, the response to search request 110 includes contextual information 112. In the example of FIG. 1, relevant metadata 130 may include portions of metadata 131 that are associated with relevant social media content 129. In another example, relevant metadata 130 may include portions of metadata 131 for items of social media content 128 that are not included in relevant social media content 129. For example, item 118 may not be included in relevant social media content 129 for search terms 123, e.g., because the content of item 118 is not relevant to search terms 123.

In this example, item 118 may be transmitted, to server 106, by a user from a geographic location referenced in search terms 123 (e.g., the highway X in San Francisco). In this example, relevant metadata 130 may include a portion of metadata 131 that is associated with item 118. The portion of metadata 131 that is associated with item 118 includes information indicative of the geographic location from which item 118 was transmitted to server 106 (e.g., from the highway X in San Francisco). Data engine 111 may use the portion of metadata 131 that is associated with item 118 in generating contextual information 112 indicative of a number of posts being transmitted from the geographic location referenced in search terms 123 (e.g., the highway X in San Francisco).

In still another example, relevant metadata 130 may include portions of metadata 131 for items of social media content 128 that are not accessible to member 105. In this example, items of social media content 128 are transmitted, to server 106, by users from a geographic location referenced in search terms 123 (e.g., the highway X in San Francisco). In this example, the users are not socially connected to member 105. In this example, relevant metadata 130 may include portions of metadata 131 that are associated with these items of social media content 128. The portions of metadata 131 that are associated with these item includes information indicative of the geographic location from which these items were transmitted to server 106. Data engine 111 may use portions of metadata 131 that is associated with these items in generating contextual information 112 indicative of a number of posts being transmitted from the geographic location referenced in search terms 123 (e.g., the highway X in San Francisco).

As previously described, data engine 111 uses relevant metadata 130 in generating contextual information 112. In an example, contextual information 112 includes a qualification of relevant metadata 130. Using contextual information 112, member 105 may quickly review information that is relevant to search terms 123, e.g., rather than reviewing the individual items of relevant social media content 129 that may be returned in response to search request 110.

In an example, a large number of people are posting items of social media content 128 from a particular geographic location (e.g., the highway X). In this example, rather than reviewing the items of relevant social media content 129, data engine 111 generates contextual information to qualify relevant metadata 130.

In this example, relevant metadata 130 includes data indicative of a number of items of social media content 128 that have been transmitted from a geographic location associated with search terms 123 (e.g., the geographic location of the highway X in San Francisco). In this example, data engine 111 generates the data indicative of a number of items of social media content 128 that have been transmitted from a geographic location associated with search terms 123 by counting a number of check-ins and/or a number of posts transmitted from the highway X in San Francisco. In this example, contextual information 112 includes the following qualification: “There are a lot more posts from the highway X in San Francisco than usual. Maybe there's an accident?”

In the example of FIG. 1, relevant social media content 129 for search terms 123 includes items 116, 120, with photographs 115, 117, respectively. In this example, items 116, 120 are associated with portions of metadata 131 specifying contents of photographs 115, 117. In this example, data engine 111 performs image recognition on photographs 115, 117 to identify the contents of photographs 115, 117. Based on performance of the image recognition, data engine 111 identifies that photographs 115, 117 include images of a fire truck. Data engine 111 stores, in metadata 131, information specifying that photographs 115, 117 include images of fire trucks.

In this example, relevant metadata 130 includes the portions of metadata 131 specifying that photographs 115, 117 include images of fire trucks. The portions of metadata 131 specifying that photographs 115, 117 include images of fire trucks are included in relevant metadata 130, at least because items 116, 120 are included in relevant social media content 129. In this example, data engine 111 generates contextual information 112 based on relevant metadata 130 specifying that photographs 115, 117 include images of fire trucks.

In this example, data engine 111 uses relevant metadata 130 in generating the following contextual information 112: “There are a lot of photos of fire trucks on highway X being posted. There may be a fire on the highway X.” In this example, contextual information 112 includes a response to search request 110 and is displayed in graphical user interface 114 as visual representation 122.

In another example, data engine 111 is configured to identify patterns in relevant metadata 130. For example, a pattern may include an increase in a number of postings submitted from a geographic location, an increase in a number of photographs submitted from a geographic location, an increase in a number of photographs included in query results, an increase in a number of photographs of a same image that are submitted from a geographic location, and so forth).

For example, a pattern may include an increase in a number of posts (and/or photographs) being transmitted from a geographic location, e.g., relative to the number of posts (and/or photographs) being from transmitted from the geographic location at a prior time. In this example, data engine 111 may be configured to use the increase in the number of posts in contextual information 112, e.g., when the increase exceeds a predefined threshold.

For example, engine 111 may be configured to display the increase in posts in contextual information 112, e.g., when the increase exceeds twenty-five percent, e.g., relative to the number of posts at a specified number of time. In still another example, a pattern may include a decrease in a number of items of social media content 128 being transmitted from a geographic location and/or pertaining to a particular topic.

In another example, a pattern includes a number of photographs of a particular object and/or event being transmitted from a particular geographic location. For example, server 106 may receive an increase in a number of photographs being transmitted from a geographic location, e.g., relative to the number of photographs being transmitted from the geographic location at a prior time.

In this example, the photographs may be of different objects and/or events. In another example, data engine 111 may be configured to detect when a threshold number of photographs (e.g., submitted from a particular geographic location) includes images of the same objects and/or event, e.g., as indicated by the metadata associated with the photographs. In this example, data engine 111 uses the threshold number of photographs detected in generating contextual information 112.

In still another example, a pattern may include an increase in a number of photographs that occur in query results, e.g., results that are responsive to search query 132. In this example, items 116, 120 may include query results with photographs 115, 117.

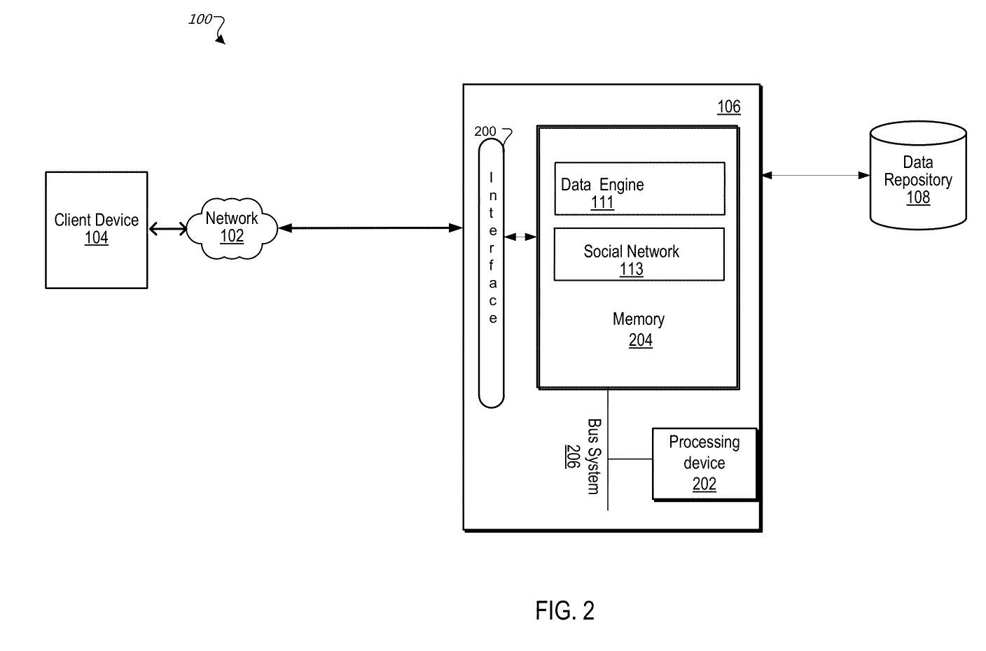

FIG. 2 is a block diagram showing examples of components of network environment 100 for generating contextual information 112 from metadata 131 for social media content 128. In the example of FIG. 2, graphical user interface 114, contents of graphical user interface 114, contents of data repository 108, search request 110, contextual information 112, search query 132, and member 105 are not shown.

Client device 104 can be a computing device capable of taking input from a user and communicating over network 102 with server 106 and/or with other computing devices. For example, client device 104 can be a mobile device, a desktop computer, a laptop, a cell phone, a personal digital assistant (PDA), a server, an embedded computing system, a mobile device, and the like. Network environment 100 can include a plurality of computing devices, which can be geographically dispersed.

Network 102 can include a large computer network, including, e.g., a local area network (LAN), wide area network (WAN), the Internet, a cellular network, or a combination thereof connecting a number of mobile computing devices, fixed computing devices, and server systems. The network(s) may provide for communications under various modes or protocols, including, e.g., Transmission Control Protocol/Internet Protocol (TCP/IP), Global System for Mobile communication (GSM) voice calls, Short Message Service (SMS), Enhanced Messaging Service (EMS), or Multimedia Messaging Service (MMS) messaging, Code Division Multiple Access (CDMA), Time Division Multiple Access (TDMA), Personal Digital Cellular (PDC), Wideband Code Division Multiple Access (WCDMA), CDMA2000, or General Packet Radio System (GPRS), among others. Communication may occur through a radio-frequency transceiver. In addition, short-range communication may occur, including, e.g., using a Bluetooth, WiFi, or other such transceiver.

Server 106 can be a variety of computing devices capable of receiving data and running one or more services, which can be accessed by client device 104. In an example, server 106 can include a server, a distributed computing system, a desktop computer, a laptop, a cell phone, a rack-mounted server, and the like. Server 106 can be a single server or a group of servers that are at a same location or at different locations. Client device 104 and server 106 can run programs having a client-server relationship to each other. Although distinct modules are shown in the figures, in some examples, client and server programs can run on the same device.

Server 106 can receive data from client device 104 through input/output (I/O) interface 200. I/O interface 200 can be a type of interface capable of receiving data over a network, including, e.g., an Ethernet interface, a wireless networking interface, a fiber-optic networking interface, a modem, and the like. Server 106 also includes a processing device 202 and memory 204. A bus system 206, including, for example, a data bus and a motherboard, can be used to establish and to control data communication between the components of server 106.

Processing device 202 can include one or more microprocessors. Memory 204 can include a hard drive and a random access memory storage device, including, e.g., a dynamic random access memory, or other types of non-transitory machine-readable storage devices. As shown in FIG. 2, memory 204 stores computer programs that are executable by processing device 202. These computer programs include data engine 111 and social network 113. Data engine 111 and social network 113 can be implemented in software running on a computer device (e.g., server 106), hardware or a combination of software and hardware.

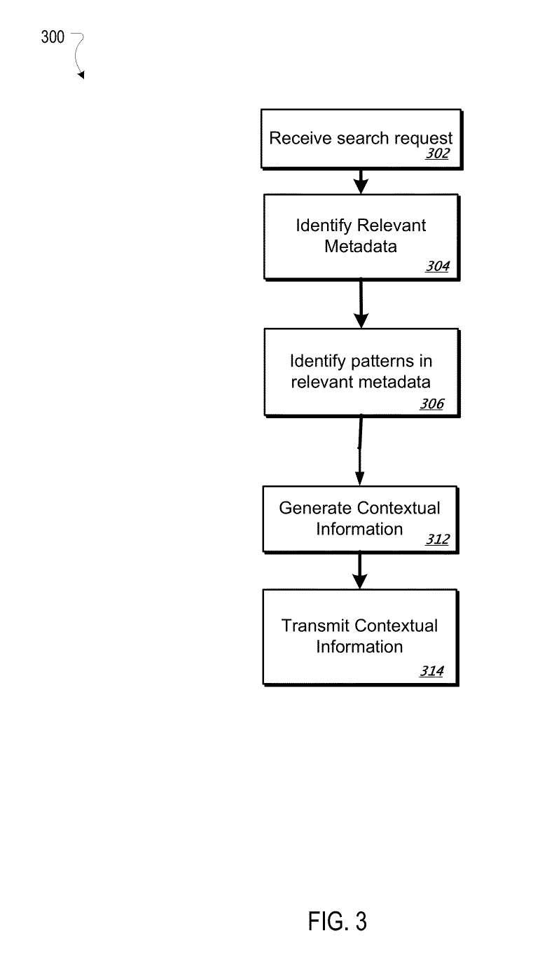

FIG. 3 is a flow chart of an example process 300 for generating contextual information 112 from metadata 131 for social media content 128. In FIG. 3, process 300 is performed on server 106 (and/or by data engine 111).

In operation, search request 110 is received (302). For example, server 106 receives (302) search request 110 with search terms 123. In response, relevant metadata 130 is identified (304). For example, data engine 111 generates search query 132. Using search query 132, data engine 111 searches metadata 131. Based on the searching, data engine 111 identifies (304) relevant metadata 130, including, e.g., portions of metadata 131 that are relevant to search terms 123.

Patterns in relevant metadata 130 are identified (306). In an example, data engine 111 may implement numerous techniques in identifying (306) patterns in relevant metadata 130. In an example, data engine 111 identifies an increase in a number of items of social media content 128 (e.g., posts and/or check-ins) that are transmitted from a geographic location associated with search terms 123. In another example, data engine 111 identifies an increase in a number of photographs that are that are transmitted from a geographic location associated with search terms 123. In still another example, data engine 111 identifies an increase in a number of photographs that are that are transmitted from a geographic location associated with search terms 123 and that include same and/or similar images. In another example, data engine 111 identifies a pattern by identifying an increase (e.g., in a number of posts and/or photographs) that exceeds a threshold hold value.

Using relevant metadata 130 and/or patterns in relevant metadata 130, contextual information 112 is generated (312). For example, data engine 111 generates (312) contextual information 112. In this example, data engine 111 generates contextual information 112 by generating a qualification of types of relevant metadata 130. In the example of FIG. 1, the qualification includes the following terms: “There are a lot of photos of fire trucks on the highway X being posted. There may be a fire on the highway X.”

Contextual information 112 is transmitted (314). For example, server 106 transmits (314) contextual information 112 to client device 104, e.g., for display in content stream 109 of graphical user interface 114 and as a response to search request 110. In another example, server 106 also transmits, to client device 104, items of relevant social media content 129, e.g., for display in content stream 109 of graphical user interface 114 and as a response to search request 110.

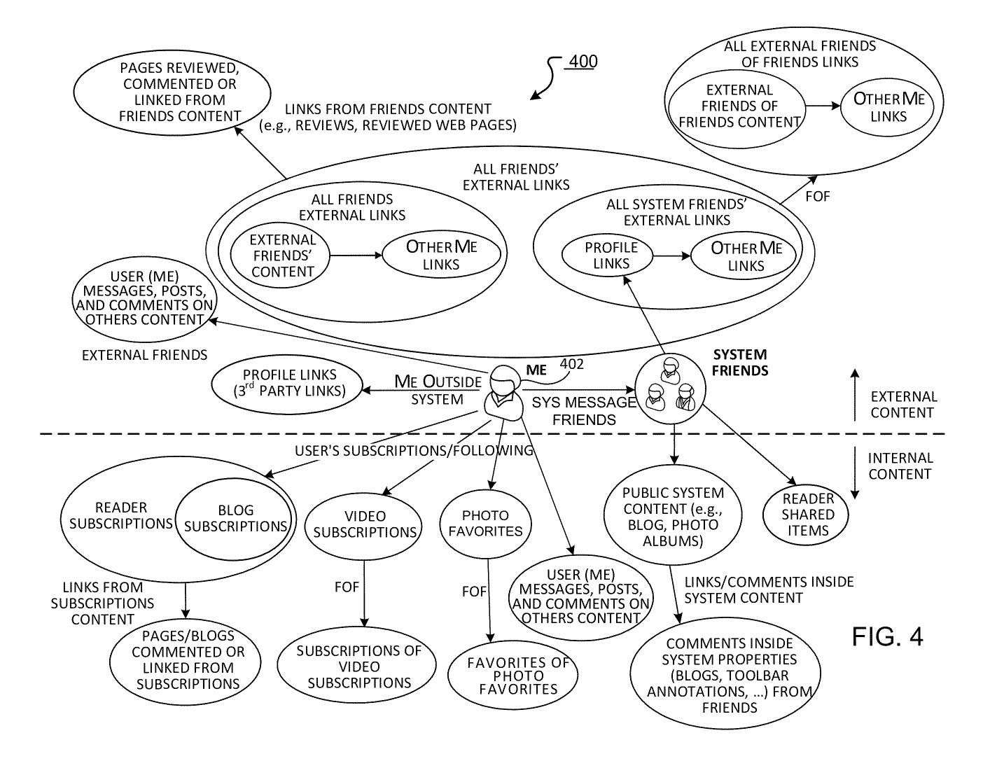

FIG. 4 is a conceptual view of an example social graph 400. Among other things, FIG. 4 shows sources of information for a social graph. In this example, the user's social graph is a collection of connections (e.g., users, resources/content, etc.) identified as having a relationship to the user 402 (“ME”) within some degree of separation. The user's social graph may include parties and particular content at different degrees of separation. For example, the social graph of a user may include contacts, contacts of contacts (e.g., as defined by a user, social graphing site, or other metric), the user's social circle, people followed by the user (e.g., subscribed blogs, feeds, or Web sites), co-workers, and other specifically identified content of interest to the user (e.g., particular Web sites).

FIG. 4 shows that it is possible to extend the user's social graph to people and content both within a single network and across one or more external networks. For example, the user may have a profile or contacts list that includes a set of identified contacts, a set of interests, a set of links to external resources (e.g., Web pages), and subscriptions to content of a system (e.g., a system that provides various content and applications including electronic messages, chat, video, photo albums, feeds, or blogs). Likewise, blogs that include links to a user's contacts may be part of the user's social graph. These groups may be connected to other users or resources at another degree of separation from the user. For example, contacts of the user may have their own profiles that include connections to resources as well as contacts of the respective contacts, a set of interests, and so forth. In another example, a user may be connected to a social network account. That social network account may reference an article in a newspaper. A social connection, therefore, may be established between the user and the author of the article.

In some implementations, the connections to a user within a specified number of degrees of separation may be considered the bounds of the social graph of a user. Membership and degree of separation in the social graph may be based on other factors, including a frequency of interaction. For example, a frequency of interaction may be by the user (e.g., how often the user visits a particular social networking site) or it may be a type of interaction (e.g., endorsing, selecting, or not selecting items associated with contacts). As interactions change, the relationship of a particular contact in the social graph may also dynamically change. Thus, the social graph may be dynamic rather than static.

Social signals may be layered over the social graph (e.g., using weighted edges or other weights between connections in the social graph). These signals, for example, frequency of interaction or type of interaction between the user and a particular connection, may be used to weight particular connections in the social graph or social graphs without modifying the actual social graph connections. These weights may change as the interaction with the user changes.

Social graphs may be stored using suitable data structures (e.g., list or matrix type data structures). Information describing an aspect of a stored social graph may be considered relationship data. For example, relationship data may include information describing how particular members of a user's social graph are connected to a user (e.g., through what social path is a particular entity connected to the user). Relationship data may also include information describing social signals incorporated in the user's social graph. In some implementations, relationship data may be stored in a relationship lookup table (e.g., a hash table). Suitable keys for locating values (e.g., relationship data) within the lookup table may include information describing the identities of both a user and a member of the user's social graph. For example, a suitable key for locating relationship data within the lookup table may be (User X, User Y), where User Y is a member of User X's social graph.

Social graph information, including that described above, may be indexed for use in information retrieval. The social graph information may be part of a search index stored in data repository 108 (FIG. 1). Accordingly, the search index may be searched to identify relevant search results that are dependent upon social signals, e.g., that are associated with one or more aspects of a user's social graph, examples of which are provided above. For example, a search system may receive a query and identify, e.g., general search results and user-generated content. The user-generated content may include, e.g., search results based on the indexed social graph information (e.g., content from electronic messages, posts, blogs, chats, etc. of members of the searcher's social graph). The indexed social graph information may be updated intermittently or periodically, for example, to include recently added information associated with the user's social graph. The indexed social graph information may also be updated, e.g., on an on-going basis to reflect relationships determined in accordance with the processes described herein.

A user may prevent addition of members to the user's social graph, e.g., using an opt-out option or by keeping contacts out of particular groups used to generate the social graph. In some implementations, privacy features provide a user with an opt-in or opt-out option to allow or to prevent, respectively, being included (or removed the user if already included) as a member of another's social graph. Thus, users may have control over what personal information or connection information, if existing, is included in their social graphs and, consequently, that is included in the content streams and search results described herein.

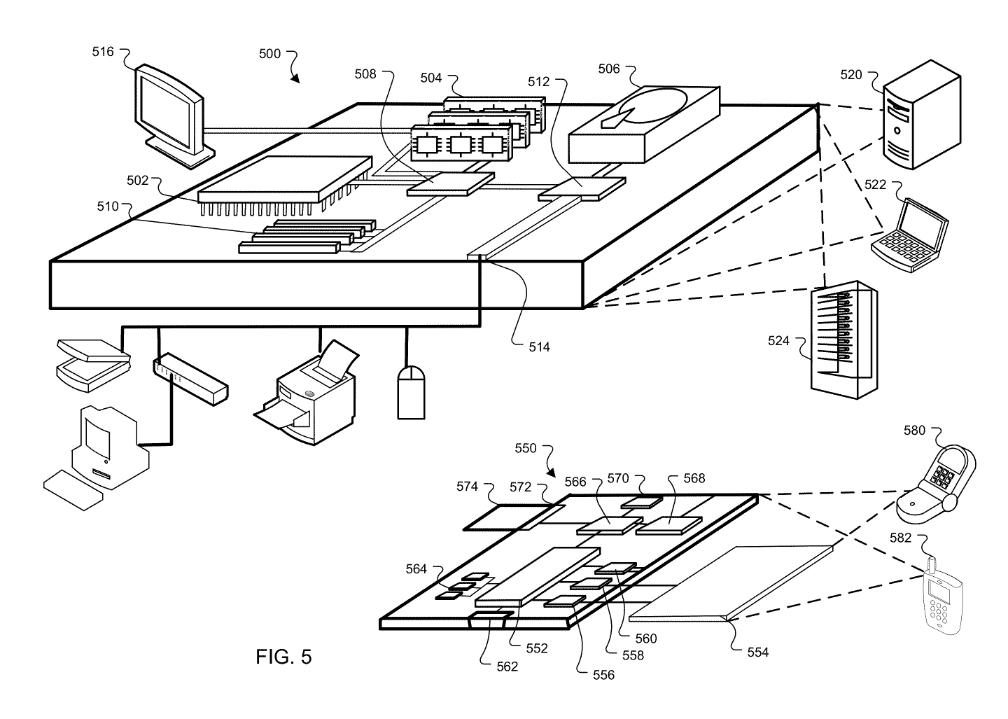

FIG. 5 shows an example of computer device 500 and mobile computer device 550, which can be used with the techniques described here. Computing device 500 is intended to represent various forms of digital computers, such as laptops, desktops, workstations, personal digital assistants, servers, blade servers, mainframes, and other appropriate computers. Computing device 550 is intended to represent various forms of mobile devices, such as personal digital assistants, cellular telephones, smartphones, and other similar computing devices. The components shown here, their connections and relationships, and their functions, are meant to be examples only, and are not meant to limit implementations of the techniques described and/or claimed in this document.

Computing device 500 includes processor 502, memory 504, storage device 506, high-speed interface 508 connecting to memory 504 and high-speed expansion ports 510, and low speed interface 512 connecting to low speed bus 514 and storage device 506. Each of components 502, 504, 506, 508, 510, and 512, are interconnected using various busses, and can be mounted on a common motherboard or in other manners as appropriate. Processor 502 can process instructions for execution within computing device 500, including instructions stored in memory 504 or on storage device 506 to display graphical data for a GUI on an external input/output device, such as display 516 coupled to high speed interface 508. In other implementations, multiple processors and/or multiple buses can be used, as appropriate, along with multiple memories and types of memory. Also, multiple computing devices 500 can be connected, with each device providing portions of the necessary operations (e.g., as a server bank, a group of blade servers, or a multi-processor system).

Memory 504 stores data within computing device 500. In one implementation, memory 504 is a volatile memory unit or units. In another implementation, memory 504 is a non-volatile memory unit or units. Memory 504 also can be another form of computer-readable medium, such as a magnetic or optical disk.

Storage device 506 is capable of providing mass storage for computing device 500. In one implementation, storage device 506 can be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in a data carrier. The computer program product also can contain instructions that, when executed, perform one or more methods, such as those described above. The data carrier is a computer- or machine-readable medium, such as memory 504, storage device 506, memory on processor 502, and the like.

High-speed controller 508 manages bandwidth-intensive operations for computing device 500, while low speed controller 512 manages lower bandwidth-intensive operations. Such allocation of functions is an example only. In one implementation, high-speed controller 508 is coupled to memory 504, display 516 (e.g., through a graphics processor or accelerator), and to high-speed expansion ports 510, which can accept various expansion cards (not shown). In the implementation, low-speed controller 512 is coupled to storage device 506 and low-speed expansion port 514. The low-speed expansion port, which can include various communication ports (e.g., USB, Bluetooth®, Ethernet, wireless Ethernet), can be coupled to one or more input/output devices, such as a keyboard, a pointing device, a scanner, or a networking device such as a switch or router, e.g., through a network adapter.

Computing device 500 can be implemented in a number of different forms, as shown in the figure. For example, it can be implemented as standard server 520, or multiple times in a group of such servers. It also can be implemented as part of rack server system 524. In addition or as an alternative, it can be implemented in a personal computer such as laptop computer 522. In some examples, components from computing device 500 can be combined with other components in a mobile device (not shown), such as device 550. Each of such devices can contain one or more of computing device 500, 550, and an entire system can be made up of multiple computing devices 500, 550 communicating with each other.

Computing device 550 includes processor 552, memory 564, an input/output device such as display 554, communication interface 566, and transceiver 568, among other components. Device 550 also can be provided with a storage device, such as a microdrive or other device, to provide additional storage. Each of components 550, 552, 564, 554, 566, and 568, are interconnected using various buses, and several of the components can be mounted on a common motherboard or in other manners as appropriate.

Processor 552 can execute instructions within computing device 550, including instructions stored in memory 564. The processor can be implemented as a chipset of chips that include separate and multiple analog and digital processors. The processor can provide, for example, for coordination of the other components of device 550, such as control of user interfaces, applications run by device 550, and wireless communication by device 550.

Processor 552 can communicate with a user through control interface 558 and display interface 556 coupled to display 554. Display 554 can be, for example, a TFT LCD (Thin-Film-Transistor Liquid Crystal Display) or an OLED (Organic Light Emitting Diode) display, or other appropriate display technology. Display interface 556 can comprise appropriate circuitry for driving display 554 to present graphical and other data to a user. Control interface 558 can receive commands from a user and convert them for submission to processor 552. In addition, external interface 562 can communicate with processor 542, so as to enable near area communication of device 550 with other devices. External interface 562 can provide, for example, for wired communication in some implementations, or for wireless communication in other implementations, and multiple interfaces also can be used.

Memory 564 stores data within computing device 550. Memory 564 can be implemented as one or more of a computer-readable medium or media, a volatile memory unit or units, or a non-volatile memory unit or units. Expansion memory 574 also can be provided and connected to device 550 through expansion interface 572, which can include, for example, a SIMM (Single In Line Memory Module) card interface. Such expansion memory 574 can provide extra storage space for device 550, or also can store applications or other data for device 550. Specifically, expansion memory 574 can include instructions to carry out or supplement the processes described above, and can include secure data also. Thus, for example, expansion memory 574 can be provide as a security module for device 550, and can be programmed with instructions that permit secure use of device 550. In addition, secure applications can be provided via the SIMM cards, along with additional data, such as placing identifying data on the SIMM card in a non-hackable manner.

The memory can include, for example, flash memory and/or NVRAM memory, as discussed below. In one implementation, a computer program product is tangibly embodied in an data carrier. The computer program product contains instructions that, when executed, perform one or more methods, such as those described above. The data carrier is a computer- or machine-readable medium, such as memory 564, expansion memory 574, and/or memory on processor 552, that can be received, for example, over transceiver 568 or external interface 562.

Device 550 can communicate wirelessly through communication interface 566, which can include digital signal processing circuitry where necessary. Communication interface 566 can provide for communications under various modes or protocols, such as GSM voice calls, SMS, EMS, or MMS messaging, CDMA, TDMA, PDC, WCDMA, CDMA2000, or GPRS, among others. Such communication can occur, for example, through radio-frequency transceiver 568. In addition, short-range communication can occur, such as using a Bluetooth®, WiFi, or other such transceiver (not shown). In addition, GPS (Global Positioning System) receiver module 570 can provide additional navigation- and location-related wireless data to device 550, which can be used as appropriate by applications running on device 550.

Device 550 also can communicate audibly using audio codec 560, which can receive spoken data from a user and convert it to usable digital data. Audio codec 560 can likewise generate audible sound for a user, such as through a speaker, e.g., in a handset of device 550. Such sound can include sound from voice telephone calls, can include recorded sound (e.g., voice messages, music files, and the like) and also can include sound generated by applications operating on device 550.

Computing device 550 can be implemented in a number of different forms, as shown in the figure. For example, it can be implemented as cellular telephone 580. It also can be implemented as part of smartphone 582, personal digital assistant, or other similar mobile device.

Using the techniques described herein, a system in configured to generate contextual information from metadata associated with social media content and that is relevant to search terms in a search request. In an example, the contextual information includes a qualification of the metadata, e.g., to describe a big picture idea surrounding the metadata.

For situations in which the systems and techniques discussed herein collect personal information about users, the users may be provided with an opportunity to opt in/out of programs or features that may collect personal information (e.g., information about a user's preferences or a user's current location). In addition, certain data may be anonymized in one or more ways before it is stored or used, so that personally identifiable information is removed. For example, a user's identity may be anonymized so that no personally identifiable information can be determined for the user, or a user's geographic location may be generalized where location information is obtained (e.g., to a city, zip code, or state level), so that a particular location of the user cannot be determined.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions.

To provide for interaction with a user, the systems and techniques described here can be implemented on a computer having a display device (e.g., a CRT (cathode ray tube) or LCD (liquid crystal display) monitor) for displaying data to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

In some implementations, the engines described herein can be separated, combined or incorporated into a single or combined engine. The engines depicted in the figures are not intended to limit the systems described here to the software architectures shown in the figures.

All processes described herein and variations thereof (referred to as “the processes”) contain functionality to ensure that party privacy is protected. To this end, the processes may be programmed to confirm that a user's membership in a social networking account is publicly known before divulging, to another party, that the user is a member. Likewise, the processes may be programmed to confirm that information about a party is publicly known before divulging that information to another party, or even before incorporating that information into a social graph.

A number of embodiments have been described. Nevertheless, it will be understood that various modifications can be made without departing from the spirit and scope of the processes and techniques described herein. In addition, the logic flows depicted in the figures do not require the particular order shown, or sequential order, to achieve desirable results. In addition, other steps can be provided, or steps can be eliminated, from the described flows, and other components can be added to, or removed from, the described systems. Accordingly, other embodiments are within the scope of the following claims.

What is claimed is:

1. A method performed by one or more processing devices, comprising:
receiving a request for social media content that is relevant to one or more search terms;
identifying, based on a social graph of a user, social media content with connections in the social graph to the user, wherein the social media content is associated with metadata;
identifying metadata that is associated with the identified social media content and that has at least a threshold amount of relevance to the one or more search terms;
generating a summarization of contents of the metadata identified and contents of the social media content identified; and
transmitting, to the device used by the user who sent the request, the summarization for presentation to the user, in response to the request for social media content.

2. The method of claim 1, further comprising:
identifying, based on at least one of the one or more search terms, a geographic location associated with the one or more search terms;
wherein identifying the metadata comprises:
identifying one or more items of social media content associated with metadata indicative of the geographic location.

3. The method of claim 2, further comprising:
determining, based on the one or more items of social media content identified, an increase in a number of items of social media content being transmitted from the geographical location.

4. The method of claim 3, wherein the summarization comprises information indicative of the increase.

5. The method of claim 2, further comprising:
determining an amount of metadata indicative of the geographic location;
wherein the summarization comprises information indicative of the amount of metadata determined.

6. The method of claim 1, further comprising:
generating, based on the one or more search terms, a search query;
wherein searching comprises:
searching based on the search query.

7. The method of claim 1, wherein transmitting comprises:
transmitting, to the device used by the user who sent the request, information for a graphical user interface that includes a visual representation of the summarization in a content stream.

8. One or more machine-readable media configured to store instructions that are executable by one or more processing devices to perform operations comprising:
receiving a request for social media content that is relevant to one or more search terms;
identifying, based on a social graph of a user, social media content with connections in the social graph to the user, wherein the social media content is associated with metadata;
identifying metadata that is associated with the identified social media content and that has at least a threshold amount of relevance to the one or more search terms;
generating a summarization of contents of the metadata identified and contents of the social media content identified; and
transmitting, to the device used by the user who sent the request, the summarization for presentation to the user, in response to the request for social media content.

9. The one or more machine-readable media of claim 8, wherein the operations further comprise:
identifying, based on at least one of the one or more search terms, a geographic location associated with the one or more search terms;
wherein identifying the metadata comprises:
identifying one or more items of social media content associated with metadata indicative of the geographic location.

10. The one or more machine-readable media of claim 9, wherein the operations further comprise:
determining, based on the one or more items of social media content identified, an increase in a number of items of social media content being transmitted from the geographical location.

11. The one or more machine-readable media of claim 10, wherein the summarization comprises information indicative of the increase.

12. The one or more machine-readable media of claim 9, wherein the operations further comprise:
determining an amount of metadata indicative of the geographic location;
wherein the summarization comprises information indicative of the amount of metadata determined.

13. The one or more machine-readable media of claim 8, wherein the operations further comprise:
generating, based on the one or more search terms, a search query;
wherein searching comprises:
searching based on the search query.

14. The one or more machine-readable media of claim 8, wherein transmitting comprises:
transmitting, to the device used by the user who sent the request, information for a graphical user interface that includes a visual representation of the summarization in a content stream.

15. An electronic system comprising:
one or more processing devices; an
one or more machine-readable media configured to store instructions that are executable by the one or more processing devices to perform operations comprising:
receiving a request for social media content that is relevant to one or more search terms;
identifying, based on a social graph of a user, social media content with connections in the social graph to the user, wherein the social media content is associated with metadata;
identifying metadata that is associated with the identified social media content and that has at least a threshold amount of relevance to the one or more search terms;
generating a summarization of contents of the metadata identified and contents of the social media content identified; and
transmitting, to the device used by the user who sent the request, the summarization for presentation to the user, in response to the request for social media content.

16. The electronic system of claim 15, wherein the operations further comprise:
identifying, based on at least one of the one or more search terms, a geographic location associated with the one or more search terms;
wherein identifying the metadata comprises:
identifying one or more items of social media content associated with metadata indicative of the geographic location.

17. The electronic system of claim 16, wherein the operations further comprise:
determining, based on the one or more items of social media content identified, an increase in a number of items of social media content being transmitted from the geographical location.

18. The electronic system of claim 17, wherein the summarization comprises information indicative of the increase.

19. The electronic system of claim 16, wherein the operations further comprise:
determining an amount of metadata indicative of the geographic location;
wherein the summarization comprises information indicative of the amount of metadata determined.

20. The electronic system of claim 15, wherein the operations further comprise:
generating, based on the one or more search terms, a search query;
wherein searching comprises:
searching based on the search query.

21. The electronic system of claim 15, wherein transmitting comprises:
transmitting, to the device used by the user who sent the request, information for a graphical user interface that includes a visual representation of the summarization in a content stream.

22. An electronic system comprising:
means for receiving a request for social media content that is relevant to one or more search terms;
means for identifying, based on a social graph of a user, social media content with connections in the social graph to the user, wherein the social media content is associated with metadata;
means for identifying metadata that is associated with the identified social media content and that has at least a threshold amount of relevance to the one or more search terms;
means for generating a summarization of contents of the metadata identified and contents of the social media content identified; and
means for transmitting, to the device used by the user who sent the request, the summarization for presentation to the user, in response to the request for social media content.
